(19) United States
(12) Patent Application Publication
(10) Pub. No.: US 2008/0036685 A1
(43) Pub. Date: Feb. 14, 2008

(54) Monopole antenna

(75) Inventor: Lung-Sheng Tai, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/890,978

(22) Filed: Aug. 8, 2007

(30) Foreign Application Priority Data
Aug. 8, 2006 (TW) 95128972

(51) Int. Cl. H01Q 3/02

(52) U.S. Cl. 343/882

(57) ABSTRACT

A monopole antenna includes an insulative substrate defining an installing aperture, a radiating element arranged on the insulative substrate and comprising a first radiating portion and a second radiating portion connecting to one end of the first radiating portion and a grounding element being separated from the radiating element and arranged on the same plane of the insulative substrate with the radiating element; wherein the second radiating portion includes a first radiating arm parallel to and separated from the first radiating portion and a second radiating arm extending from the first radiating arm agley, wherein the first radiating portion and the second radiating portion form a C shape and extend along the edge of the insulative substrate, and the grounding element comprises a fixing hole which is superposed with said installing aperture of said insulative substrate.

### BACKGROUND OF THE INVENTION

1. Field of the Invention

The present invention relates generally to a monopole antenna, and more particularly to an antenna assembling on exterior of an electronic device, such as notebook.

2. Description of the Prior Art

Since the wireless communication technology of using electromagnetic wave to transmit signals has the effect of remote device transmission without cable connection, and further has the mobility advantage, therefore the technology is widely applied to various products, such as mobile phones, notebook computers, intellectual home appliance with wireless communication features. Because these devices use electromagnetic wave to transmit signals, the antenna used to receive electromagnetic wave also becomes a necessity in the application of the wireless communication technology. Antennas comprise internal antennas and outer antennas to adapt to different structures of different electronic devices. Outer antennas are able to turn to different directions to achieve optimum efficiency of receiving and transmitting signals. The type of outer antennas are usually monopole antennas or spiral antennas, which are always set in an insulative cover to be assembled on an electronic device together with the insulative cover. To adapt to the miniature trend of the electronic devices, the outer antennas are needed to has small-size. U.S. Pat. No. 6,801,169 discloses a small-size dual-band monopole antenna. The monopole antenna is fixed on a PCB, and comprises a C-shape radiating element, an L-shape grounding element and a feeding line connecting to the radiating element and the grounding element. However, the antennas with the connecting method between the radiating element and the feeding line disclosed in this patent do not suit to be set in an outer insulative cover of an electronic device.

Hence, an improved antenna with simple structure and small-size is desired to overcome the above-mentioned shortcomings of the existing antennas.

### BRIEF SUMMARY OF THE INVENTION

A primary object, therefore, of the present invention is to provide a monopole antenna which is able to rotate to an outer position outward an electronic device and has simple structure and small-size.

In order to implement the above object and overcomes the above-identified deficiencies in the prior art, the monopole antenna comprises a insulative substrate, a radiating element and a grounding element; the insulative substrate defines an installing aperture; the radiating element is located on the insulative substrate and comprises a first radiating portion and a second radiating portion connecting to one end of the first radiating portion, the second radiating portion comprising a first radiating arm parallel to and separated from the first radiating portion and a second radiating arm extending from the first radiating arm agley, wherein the first radiating portion and the second radiating portion forming a C shape and extending along the edge of the insulative substrate; the grounding element is separated from the radiating element and on the same planar of the insulative substrate as the radiating element, wherein said grounding element comprises a fixing hole which is superposed with said installing aperture of said insulative substrate.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating a preferred embodiment of a monopole antenna of the present invention assembled on an electronic device; and

FIG. 2 is a perspective view illustrating a preferred embodiment of a monopole antenna of the present invention.

### DETAILED DESCRIPTION OF THE INVENTION

Reference will now be made in detail to a preferred embodiment of the present invention.

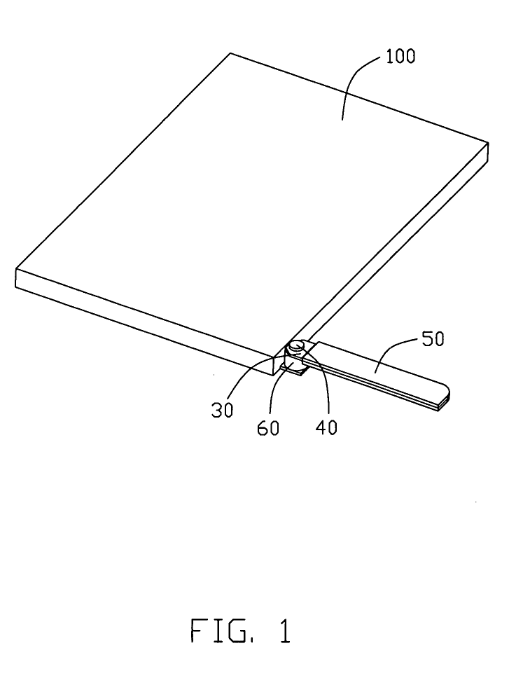

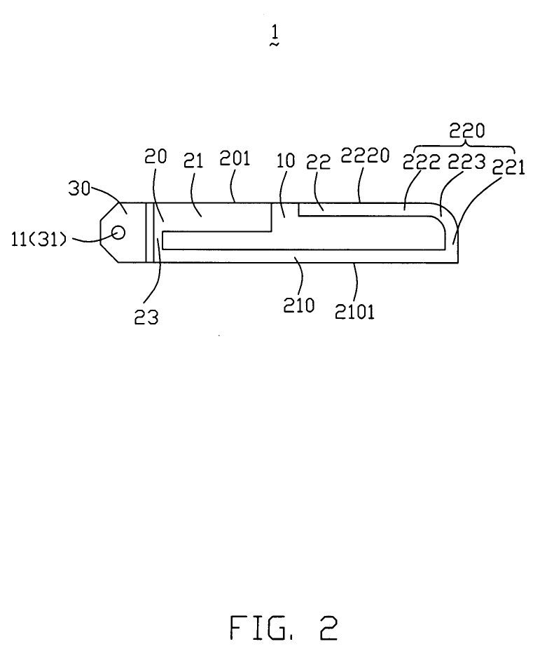

Reference to FIG. 1 to FIG. 2, perspective views of a monopole antenna 1 in accordance with a preferred embodiment of the present invention are shown. And FIG. 1 shows an insulative cover 50 assembled on an electronic device with the monopole antenna 1 therein.

The monopole antenna 1 comprises an insulative substrate 10, a radiating element 20 and a grounding element 30. The radiating element 20 and the grounding element 30 are both arranged on the same plana of the insulative substrate 10. The insulative substrate 10 comprises an installing aperture 11 on one end thereof. The radiating element 20 comprises a flat first radiating portion 21, a second radiating portion 22 and a vertical connecting portion 23 connecting one end of the first radiating portion 21 with the second radiating portion 22. The first radiating portion 21 is wider than the second radiating portion 22 and the width of the first radiating portion 21 is adjustable to regulate the impedance. The second radiating portion 22 comprises a longer horizontal first radiating arm 210 and an L-shape second radiating arm 220 extending from the first radiating arm 210 along a vertical direction perpendicular to the first radiating arm 210. The second radiating arm 220 comprises a first side section 221 extending from the first radiating arm 210 in a vertical direction to the first radiating arm 210 and a second side section 222 extending from the first side section 221 along a direction perpendicular to the first side section 221, thus, forming an arc section 223 on the joint of the first side section 221 and the second side section 222. The second side section 222 extends toward the first radiating portion 21 with a free end thereof separated from the first radiating portion 21 with a certain distance. The first radiating portion 21 defines a first edge 201, the second radiating portion 22 defines a second edge 2101, and the second side section 222 defines a third edge 2220 aligning with the first edge 201. The first radiating arm 210 of second radiating portion 22 has the same width as that of the second radiating arm 220. The first radiating portion 21 and the second radiating portion 22 together form C shape. The distance from the first edge 201 and the second edge 2220 to the third edge 2101 is same as the width of the insulative substrate 10. The first radiating portion 21 is used to receive and send a first frequency signal, and the second radiating portion 22 is used to receive and send a second frequency signal.

There is a gap formed between the grounding element 30 and the radiating element 20, and the grounding element 30 comprises a fixing hole 31 which is superposed with the installing aperture 11 to form a channel with the installing aperture 11. The channel is used to fix the monopole antenna 1 to the electronic device 100. The feeding line (not shown) of the monopole antenna 1 comprises an inner conductor connecting with any position of the connecting portion 23, and an outer conductor connecting with a grounding point (not shown) of the grounding element 30. The monopole antenna 1 also comprises an insulative cover 50 to enclose the insulative substrate 10 and the radiating element 20, that is to say, the grounding element 30 is exposed in a space outside the insulative cover 50. Both of the radiating element 20 and the grounding element 30 are made from a metal patch, and then are sticked to an insulative substrate. In other embodiment, the monopole antenna 1 is able to be made by an etching method used on an insulative substrate.

The first radiating portion 21 of the monopole antenna 1 is used to receive and send signals of a first frequency band in 824-960 MHz and a second frequency band in 1710-2170 MHz by bringing a second harmonic generation. The second radiating portion 22 is used to receive and send signals of the second frequency band to increase the band width of the second frequency band. On the other hand, the second radiating portion 22 is also used to transfer higher frequency signals like 2.3 MHz.

The electronic device 100 comprises a pivot 40 threading through the channel to fix the monopole antenna 1 and make the monopole antenna 1 be able to axially rotate 180 degrees. In other embodiment, the insulative cover 100 of the electronic device can have an accepting groove whose one end can hold a fixing axis 60. Thus, the monopole antenna 1 can turn to a position inside the accepting groove to form a accepting position and some other positions outside the accepting groove to form open positions. When the accepting groove located in the joint area of the side and the top of the monopole antenna 1, the antenna 1 can axially rotate 180 degrees. In other embodiments, some other different assembling methods can be used to connect the monopole antenna 1 and the electronic device. But the same means to define a pair of superposed installing aperture respectively on the grounding element 30 and the insulative substrate 10 and a C-shape radiating element 20 to make fully use of the space on the insulative substrate 10 can achieve the monopole antenna 1 small-size and having enough band width.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

What is claimed is:

1. A monopole antenna comprises:
an insulative substrate defining an installing aperture;
a radiating element arranged on the insulative substrate and comprising a first radiating portion and a second radiating portion connecting to one end of the first radiating portion, the second radiating portion comprising a first radiating arm parallel to and separated from the first radiating portion and a second radiating arm extending from the first radiating arm agley, wherein the first radiating portion and the second radiating portion form a C shape and extend along the edge of the insulative substrate; and
a grounding element being separated from the radiating element and arranged on the same plane of the insulative substrate with the radiating element, wherein said grounding element comprises a fixing hole which is superposed with said installing aperture of said insulative substrate.

2. The monopole antenna as claimed in claim 1, wherein said radiating element has a width same as that of said insulative substrate.

3. The monopole antenna as claimed in claim 1, wherein said monopole antenna comprises a first frequency band formed by said first radiating portion, and a second frequency band produced by a second harmonic generation brought by the first radiating portion.

4. The monopole antenna as claimed in claim 3, wherein said second radiating portion work at the second frequency band to increase the band width of the second frequency band.

5. The monopole antenna as claimed in claim 3, wherein said second radiating portion work at the second frequency band and a third frequency band whose frequency is higher than the second frequency band at least.

6. The monopole antenna as claimed in claim 3, wherein said first frequency band is on 824-960 MHz and said second frequency band is on 1710-2170 MHz.

7. The monopole antenna as claimed in claim 2, wherein said first radiating portion has a width which is wider than the width of the second radiating portion, the width of the first radiating portion is adjustable to adapt the impedance match.

8. The monopole antenna as claimed in claim 1, wherein said second radiating arm of the second radiating portion comprises a first side section extending from the first radiating portion in a vertical direction to the first radiating portion and a second side section extending from the first side section agley.

9. The monopole antenna as claimed in claim 8, wherein said second side section extends towards the first radiating portion in a perpendicular direction to the first side section, and is parallel to the first radiating arm.

10. The monopole antenna as claimed in claim 8, wherein said first radiating portion has an end connecting the second radiating portion and the other end separated from the end of the second side section of the second radiating portion with a certain distance.

11. The monopole antenna as claimed in claim 8, wherein said first side section electrically connects the second side section through an arc section.

12. The monopole antenna as claimed in claim 1, wherein said monopole antenna is pivotally assembled on the electronic device.

13. An antenna assembly comprising a planar type electronic device defining a peripheral edge with a pivot structure formed thereon, a planar antenna pivotally mounted on said pivot structure under a condition that a pivotal axis is essentially perpendicular to a plane defined by said planar antenna.

14. The antenna assembly as claimed in claim 13, wherein said plane is essentially parallel to a main plane defined by said electronic device.

15. The antenna assembly as claimed in claim 13, wherein said pivot structure is located around a corner of said electronic device and allows the planar antenna rotates with 180 degrees.

16. The antenna assembly as claimed in claim 13, wherein a ground portion of said antenna is locate adjacent to said pivot structure.

17. The antenna assembly as claimed in claim 13, where the antenna includes two radiating sections of which one is closer to the pivot structure than the other.
